(19) United States
(12) Patent Application Publication
(10) Pub. No.: US 2016/0068092 A1
(43) Pub. Date: Mar. 10, 2016

(54) Multi-Stage Telescopic Cylinders With Individual Controlled Stages

(71) Applicant: The Heil Co., Chattanooga, TN (US)

(72) Inventors: Charles A. DUELL, Crestline, OH (US); Albert JIANG, Chattanooga, TN (US)

(21) Appl. No.: 14/844,320

(22) Filed: Sep. 3, 2015

Related U.S. Application Data
(60) Provisional application No. 62/045,712, filed on Sep. 4, 2014.

(51) Int. Cl. B60P 1/64; F15B 15/16

(52) U.S. Cl. CPC B60P 1/6409; B60P 1/6454; F15B 15/16

(57) ABSTRACT

A vehicle hoist telescopic stage cylinder has first and second stage cylinders. A control is fluidly coupled with the first and second stage cylinders. The control valve moves fluid to and from the first stage cylinder independent of the second stage cylinder. Also, it moves fluid to and from the second stage cylinder independent of the first stage cylinder. The first stage cylinder extends and retracts independently of the second stage cylinder. The second stage cylinder extends and retracts independently of the first stage cylinder.

### CROSS-REFERENCE TO RELATED APPLICATIONS

This application claims the benefit of U.S. Provisional Application No. 62/045,712, filed on Sep. 4, 2014. The entire disclosure of the above application is incorporated herein by reference.

### FIELD

The present disclosure relates to telescopic multi-stage cylinders and, more particularly, to telescopic multi-stage hydraulic cylinders with individually controlled stages.

### BACKGROUND

Telescopic multi-stage cylinders are used in various applications. Specifically, telescopic multi-stage cylinders are utilized to lift vehicle hoist frames. Particularly, these telescopic multi-stage cylinders are utilized in refuse vehicles. The telescopic cylinders are utilized to raise the hoist so that a refuse container can be removed or withdrawn from or raised onto the hoist.

Ordinarily, telescopic multi-stage hydraulic cylinders used on hoists require the hydraulic fluid to enter from one cylinder stage to the next to the next stage. Thus, the raising and lowering of the hoist is based upon the numerous extensions of the multi-stage cylinder. Thus, the multi-stage cylinder must expand and retract in series in order to raise and lower the hoist. These telescopic multi-stage cylinders avail themselves to misstaging under overcenter loads. This is due to the fact that the telescopic multi-stage cylinders do not provide positive positioning of an overcenter load. Accordingly, the container load forces dictate movement of the telescoping multi-stage cylinders. Thus, it is possible for the hoist to retract without a positive positioning of the hoist or the opposite; the hoist raises up. Both are undesirable and can happen even with an experienced driver

### SUMMARY

According to the present disclosure, a telescopic multi-stage cylinder eliminates potential misstaging of the multi-stage cylinder. Additionally, the present disclosure provides a telescopic multi-stage cylinder that provides positive positioning of an overcenter load.

According to the disclosure, a telescopic multi-stage cylinder for a vehicle hoist comprises a first stage cylinder and a second stage cylinder positioned inside of the first stage cylinder. A control valve controls fluid into the first and second stage cylinders. The control valve fluidly couples with the first and second stage cylinders. The control valve moves fluid to and from the first stage cylinder independent of the second stage cylinder. Also, the control valve moves fluid to and from the second stage cylinder independent of the first stage cylinder. Thus, the first stage cylinder extends and retracts independently of the second stage cylinder. Likewise, the second stage cylinder extends and retracts independently of the first stage cylinder. An auxiliary control valve moves the control valve between positions where the control valve couples with the first and second cylinders. A manually operated control operates the auxiliary control.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a refuse vehicle in accordance with the present disclosure.

FIG. 2 is a schematic view of a controlled telescopic cylinder.

FIG. 3 is a second embodiment of the controlled telescopic cylinder.

FIG. 4 is a third embodiment of the controlled telescopic cylinder.

FIG. 5 is a fourth embodiment of the controlled telescopic cylinder.

FIG. 6 is a fifth embodiment of the controlled telescopic cylinder.

FIG. 7 is a sixth embodiment of the controlled telescopic cylinder.

FIG. 8 is a seventh embodiment of the controlled telescopic cylinder.

FIG. 9 is an eighth embodiment of the controlled telescopic cylinder.

FIG. 10 is a ninth embodiment of the controlled telescopic cylinder.

FIG. 11 is a tenth embodiment of the controlled telescopic cylinder.

### DETAILED DESCRIPTION

Example embodiments will now be described more fully with reference to the accompanying drawings.

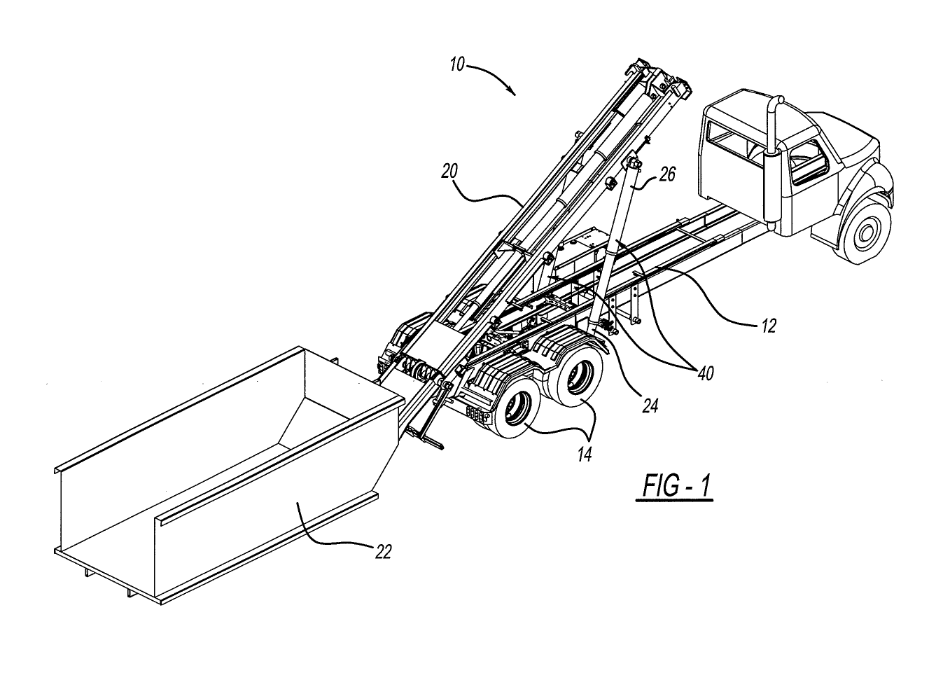

Turning to FIG. 1, a refuse vehicle is illustrated and designated with the reference numeral 10. The refuse vehicle includes a chassis frame 12, wheels 14 and a cab 16. A hoist frame 20 is illustrated for lifting a container 22. The hoist frame 20 includes at least one telescopic multi-stage cylinder 40. The telescopic multi-stage cylinder 40 is shown with the rod end 24 secured to the chassis frame 12 and the barrel 26 (base end) is secured to the hoist frame 20. The telescopic cylinder 40 can be installed in the opposite direction that is with the barrel 26 (base end) secured to the chassis frame 12 and the rod end 24 secured to the hoist frame 20.

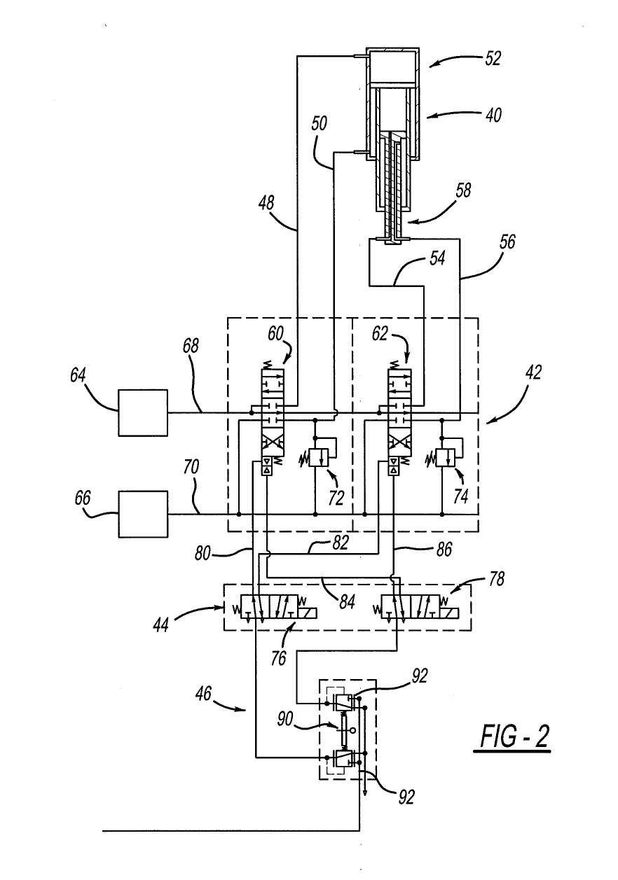

Turning to FIG. 2, a schematic for operating the multi-stage telescopic cylinder is illustrated. The telescopic multi-stage cylinder 40 is fluidly coupled with a control valve 42. The control valve 42 has an auxiliary valve 44. The auxiliary valve 44 moves the control valve 42 between positions to couple with a first stage cylinder and/or a second stage cylinder. Additionally, a manually operated control 46 may be coupled with the auxiliary control 44.

The control valve 42 includes conduit 48, 50 that independently connect the control valve with the first stage 52 of the telescopic multi-stage cylinder 40. Additionally, conduits 54, 56 fluidly couple the control valve 42 with the second stage cylinder 58 of the multi-stage cylinder 40. While only two stages are shown, it is understood that the disclosure can relate to more than two stages.

The control valve 42 is moved between the first stage cylinder 52 and second stage cylinder 58. Thus, each stage cylinder 52, 58 is operated independently of the other. Accordingly, the first stage cylinder 52 is extended and retracted independent of the movement of the second stage cylinder 58. Additionally, the second stage cylinder 58 is extended and retracted independent of the movement of the first stage cylinder 52.

The control valve 42 includes a pair of directional control valves 60, 62. The directional control valves 60, 62 are coupled with the conduits 48 and 50, 54 and 56, respectively. Additionally, the directional control valves 60, 62 are connected with a hydraulic pressure source 64 and a return tank 66. The pressure source 64 includes a conduit 68 that supplies fluid under pressure to both directional valves 60, 62. Additionally, the tank 66 includes a conduit 70 that is coupled with the directional valve 60, 62 to return the fluid to the tank 66.

Relief valves 72, 74 are positioned in return lines 50, 56, respectively. The relief valves 72, 74, if necessary, release pressure on the valves 60, 62 and return the fluid to the tank 66. Preferably, the directional valve 60, 62 are spool type valves and are controlled by the auxiliary control valve 44. The auxiliary control valve 44 includes a pair of air solenoid valves 76, 78. The air solenoid valves 76, 78 are fluidly coupled with the spool valves 60, 62, respectively, via conduits 80, 82, 84, 86. Thus, the directional valves 60, 62 can be driven in opposite directions.

The manual operated control 46 actuates the auxiliary control 44. The manual activated control 46 includes a manual joy stick 90 to supply pressurized air to air solenoid valves 76, 78, respectively. Additionally, the manual joy stick 90 includes an electric control switch 92, that is a 3-position momentary rocker switch, to activate the air solenoid valves 76, 78.

The telescopic multi-stage cylinder 40 operates as follows. With the hoist in a down position, the operator, in the cab 16, moves air control joy stick 90 into a first position. This actuates the hydraulic directional control valve 60. The control valve 60 directs fluid through conduit 48 to the extend side of the first stage cylinder 52 to raise the hoist 20. When the first stage cylinder 52 is fully extended, the operator activates the electrical control switches 92. Activation of the switch 92 activates the solenoid of air solenoid valve 76. When the solenoid of air solenoid valve 76 is activated, fluid is be released from the directional control valve 60 that controls the extended side of the first stage cylinder 52. The control valve 60 redirects the fluid to the directional control valve 62. The control valve 62 controls the extended side, via conduit 54, of the second stage 58. This extends the second stage cylinder 58 to an extended position to raise the hoist frame 20. When the hoist frame 20 has been elevated to a desired height, the operator releases the joy stick 90. The joy stick 90 returns to a neutral position to enable the control valve 60 to return to its first position.

In order to lower the hoist frame 20, the operator moves the joy stick lever 90 in a second direction. This actuates the directional control valve 62 to direct fluid flow to the retract side via conduit 56. This retracts the second stage cylinder 58. When the second stage cylinder has been completely retracted, the operator activates the electric switch 92. The electric switch 92 activates the solenoid of air solenoid valve 78. When the solenoid, of air solenoid valve 78, is activated, fluid is released from the directional control valve 62. This controls the retracted side of the second stage cylinder 58 and redirects the fluid to the directional control valve section of control valve 60. Control valve 60 controls retraction of the first stage cylinder 52. This continues until the hoist frame 20 is lowered to a first position. When the hoist frame 20 has been fully lowered, the operator releases the joy stick 90. The joy stick 90 returns to its first position to enable the control valve 60 to return to a neutral position. The operator can stop and reverse the direction of the hoist frame 20 travel at any time he desires during the loading and unloading of the container 22. Thus, the telescopic multi-stage cylinder 40 maintains positive positioning on the load at all times. Accordingly, the telescopic multi-stage cylinder 40 is loaded with a force independent of the direction of the load forces of the container load. Thus, this results in the maintaining position on the load at all times. Optional counter balance vales can be used in the extend and retract end of either stage and or both stages.

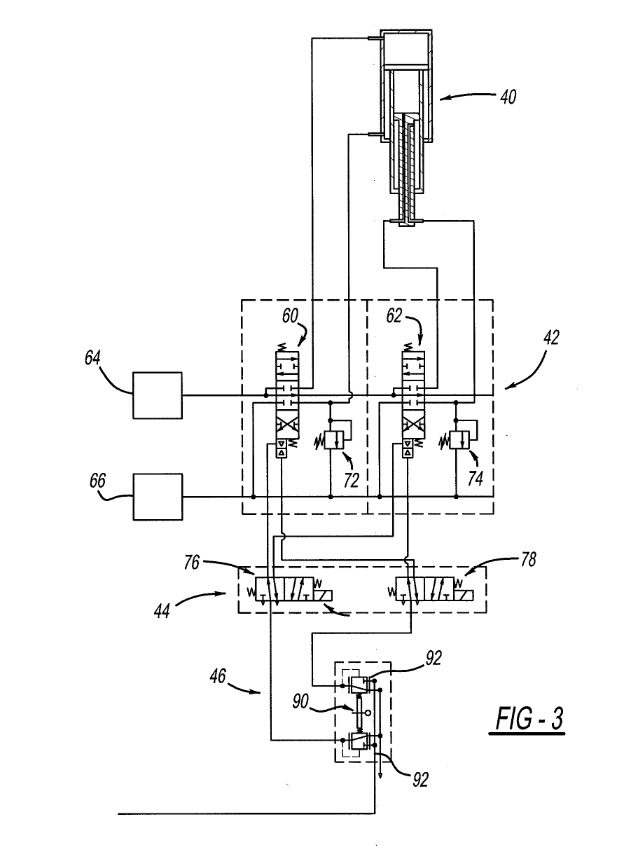

Turning to FIG. 3, an additional embodiment of the telescopic multi-stage cylinder and control is illustrated. The same reference numerals are utilized to identify the same elements. Here, an electrical contact 92′ is substituted for the electrical switch 92 of the embodiment illustrated in FIG. 2.

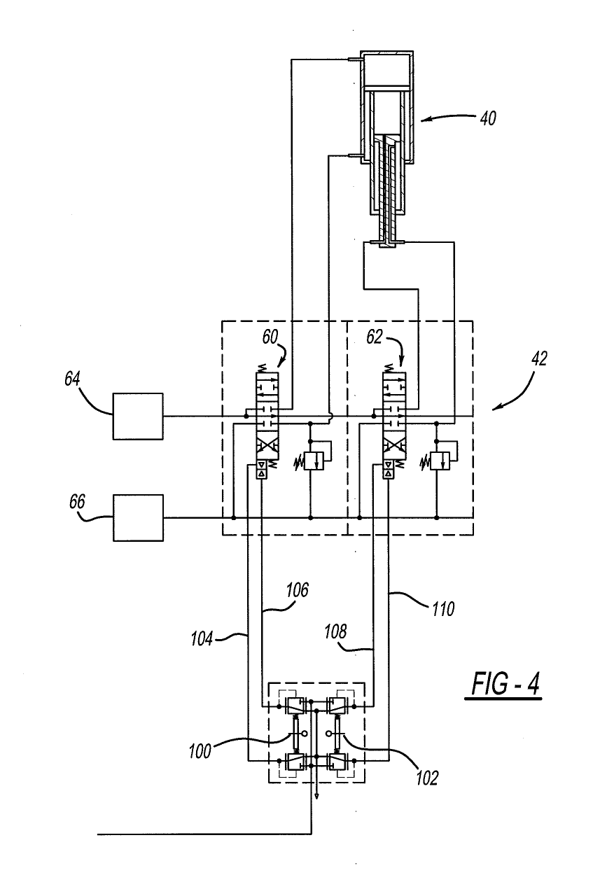

Turning to FIG. 4, an additional embodiment is illustrated. The same elements have been identified with the same reference numerals. Here, a pair of joy sticks 100, 102 are illustrated directly coupled via conduits 104, 106 and 108, 110, respectively, with directional control valves 60, 62.

The joy stick 100 is moved in a first direction. The control valve 60 extends the first stage cylinder 52, as described above. The joy stick 100 is released to a neutral position so that fluid flows to valve 62. The joy stick 102 is moved in a first direction to enable the directional valve 62 to extend the second stage cylinder 58. To retract the second stage cylinder 58, the joy stick 102 is moved in a second direction. The control valve 62 moves to enable the second stage cylinder 58 to retract. Once this is done, the joy stick 102 is returned to its neutral position and the joy stick 100 is moved in the second direction. This enables the fluid to be released from the first stage cylinder and enable the hoist 20 to move into a lowered position.

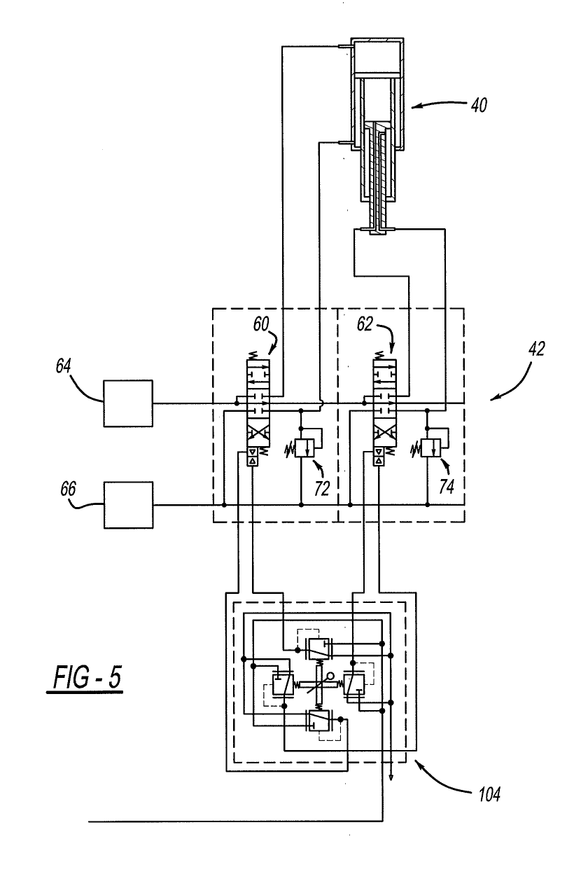

FIG. 5 is an additional embodiment. The elements, which are the same, have been identified with the same reference numerals.

In FIG. 5, the joy stick moves in four directions. The four directional movements correspond with the movements of the joy sticks 100, 102. Thus, instead of moving the two joy sticks, as illustrated in FIG. 4, joy stick 104 is moved in a single direction which provides for the one movement described in FIG. 4.

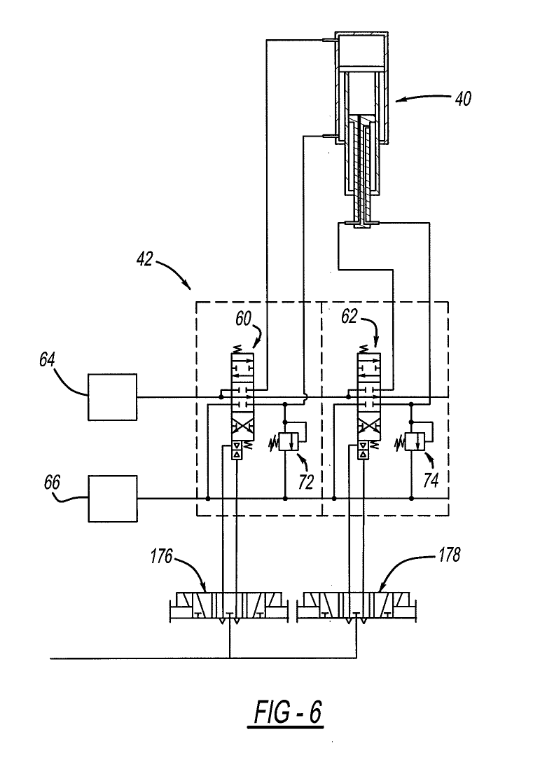

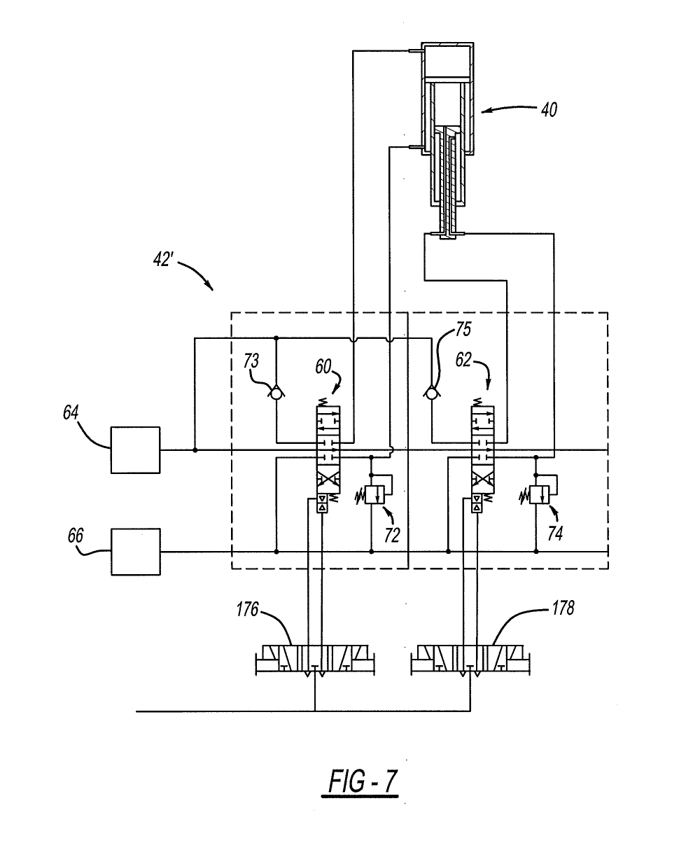

Turning to FIGS. 6 and 7, additional embodiments are shown. The elements, which are the same, have been designated with the same reference numerals.

FIG. 6 illustrates a control valve operating in series. FIG. 7 illustrates a similar control valve operating in parallel. The manually operated solenoid valves 176, 178 are operated to move the directional valves 61, 62 between their positions for extending and retracting the first stage cylinder 52 and the second stage cylinder 58, as described above. In FIG. 7, valve 42′ includes check valves 73 and 75.

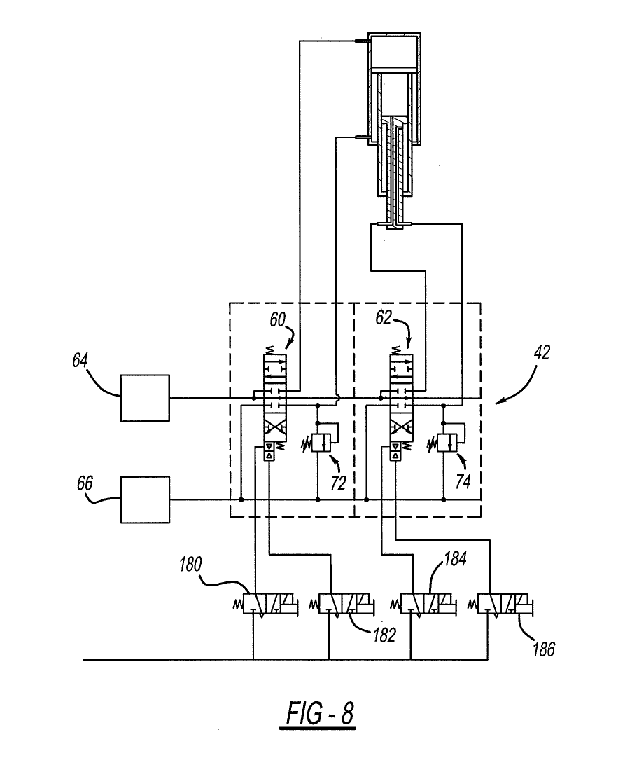

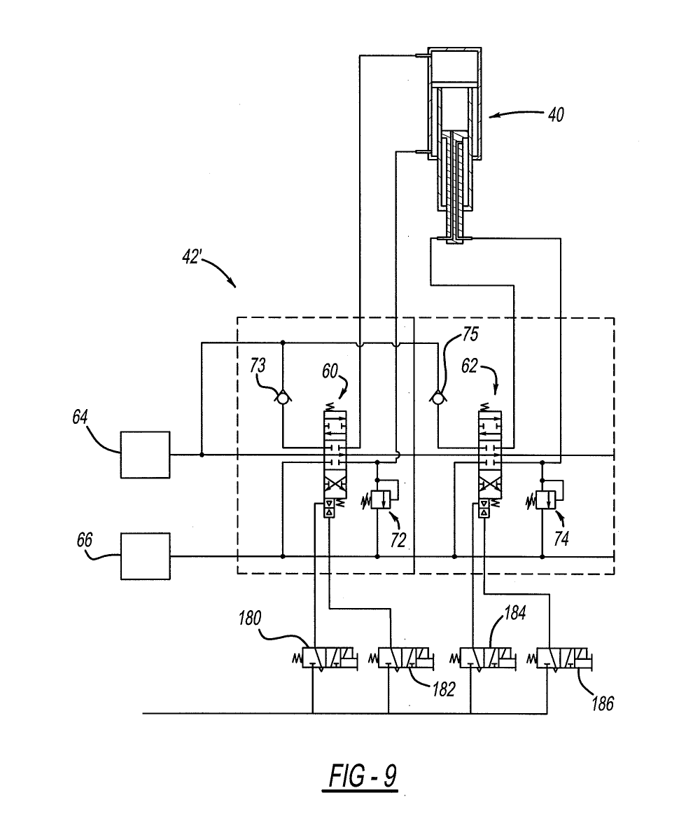

FIGS. 8 and 9 illustrate additional embodiments. The reference numerals for like elements have been used to identify the same. FIGS. 8 and 9 are like FIGS. 6 and 7 having a series and parallel circuit. However, the solenoid valves 180-186 are two position valves and thus necessitate a single valve for a single line unlike the three position valves of the embodiments illustrated in FIGS. 6 and 7. Thus, the solenoid valves 180-186 must be activated individually in order to retract and extend the first 52 and second 58 stage cylinders.

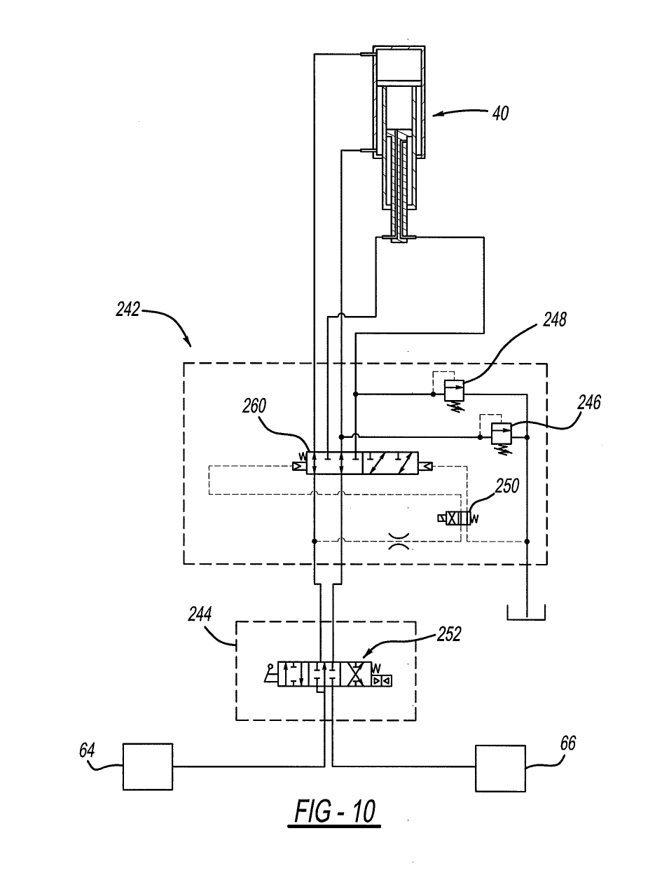

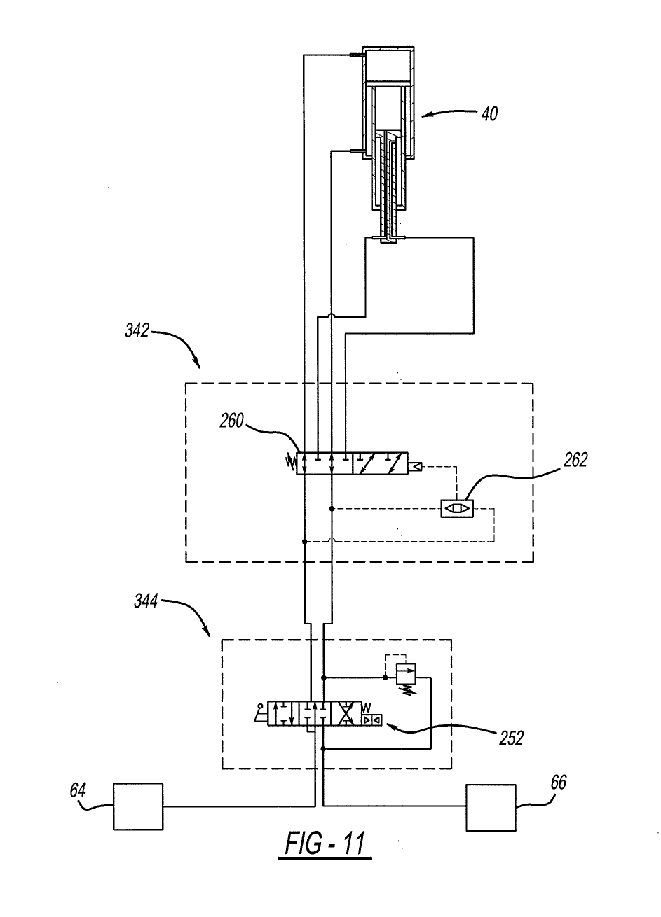

FIGS. 10 and 11 illustrate additional embodiments. Previous reference numerals are utilized to identify the same elements.

The control valve 242 includes a six-way two position manifold 260. Relief valves 246, 248 are coupled with the return lines 50, 56. A hydraulic pilot solenoid operated valve 250 moves the six-way two position manifold between positions.

An auxiliary valve 244 controls the fluid through the control valve 242. The auxiliary valve 244 includes a manually operated directional valve 252. The valve 252 can be manually operated to move between positions to enable the first stage cylinder 52 to move between an extended and retracted position. Also, the manifold 260 can be moved to enable the directional valve to supply fluid to the second stage cylinder 58.

FIG. 11 illustrates a control valve 342 and an auxiliary valve 344. The control valve 342 includes a six-way two position manifold 260 without relief in the manifold. A hydraulic pilot 262 is coupled with the fluid pressure and return lines to move the manifold 260 between positions.

The auxiliary valve 344 includes a manually operated directional valve 252. It is operated to enable fluid to move into the first stage cylinder 52. Once the six-way manifold 260 is operated, it enables fluid to move into the second stage cylinder 58. Also, movement of the directional valve enables retraction of the first and second stage cylinders.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A telescopic stage cylinder for a vehicle hoist comprising:
a first stage cylinder and a second stage cylinder positioned inside the first stage cylinder;
a control valve for controlling fluid into the first and second stage cylinders, the control valve fluidly coupled with the first and second stage cylinders such that the control valve moves fluid to and from the first stage cylinder independent of the second stage cylinder and the control valve moves fluid to and from the second stage cylinder independent of the first stage cylinder so that the first stage cylinder extends and retracts independently of the second stage cylinder and the second stage cylinder extends and retracts independently of the first stage cylinder.

2. The telescopic stage cylinder of claim 1, further comprising an auxiliary control for moving the control valve between a position fluidly coupling with the first or second stage cylinders.

3. The telescopic stage cylinder of claim 2, further comprising a manually operated control for operating the auxiliary control.

4. The telescopic stage cylinder of claim 1, further comprising a manually operated control for moving the control valve between positions fluidly coupling with the first and/or second stage cylinders.

5. The telescopic stage cylinder of claim 3, wherein the manually operated control includes a joy stick and an electric control switch.

6. The telescopic stage cylinder of claim 4, wherein the manually operated control includes a pair of joy sticks and a pair of switches.

7. The telescopic stage cylinder of claim 4, wherein the manually operated control includes a joy stick and four switches.

8. The telescopic stage cylinder of claim 4, wherein the manually operated control includes manually operated solenoid valves.

9. The telescopic stage cylinder of claim 4, wherein the manually operated control includes four two position valves.

10. The telescopic stage cylinder of claim 4, wherein the manually operated control includes a manually operated directional valve.

11. A method of raising and lowering a hoist frame comprising:
providing a hoist frame on a chassis frame, at least one telescopic stage cylinder with a control valve controlling fluid into a first and a second stage of the at least one telescopic stage cylinder, the control valve moves fluid to and from the first and second stage cylinders independent of one another;
operating the control valve to raise and lower the hoist frame with respect to the chassis; and
maintaining a positive positioning on a load on the hoist frame during operation of the hoist frame.

12. The method of raising and lowering a hoist frame of claim 11, further comprising providing a force in the at least one multi-stage cylinder during the cycle that is independent of a force applied by the load on the hoist frame.

13. A refuse vehicle comprising:
a chassis frame, wheels, a cab and a hoist frame;
at least one telescopic multi-stage cylinder coupled between the chassis frame and the hoist frame;
the at least one telescopic multi-stage cylinder comprising:
a first stage cylinder and a second stage cylinder positioned inside the first stage cylinder;
a control valve for controlling fluid into the first and second stage cylinders, the control valve fluidly coupled with the first and second stage cylinders such that the control valve moves fluid to and from the first stage cylinder independent of the second stage cylinder and the control valve moves fluid to and from the second stage cylinder independent of the first stage cylinder so that the first stage cylinder extends and retracts independently of the second stage cylinder and the second stage cylinder extends and retracts independently of the first stage cylinder.

14. The refuse vehicle of claim 13, further comprising an auxiliary control for moving the control valve between a position fluidly coupling with the first or second stage cylinders.

15. The refuse vehicle of claim 14, further comprising a manually operated control for operating the auxiliary control.

16. The refuse vehicle of claim 13, further comprising a manually operated control for moving the control valve between positions fluidly coupling with the first and/or second stage cylinders.

17. The refuse vehicle of claim 16, wherein the manually operated control includes a pair of joy sticks and a pair of switches.
